(19) United States
(12) Patent Application Publication
(10) Pub. No.: US 2025/0322670 A1
(43) Pub. Date: Oct. 16, 2025

(54) PERCEPTION AND VEHICLE DYNAMICS FUSION FOR SYSTEM DISABLING IN A PARKING LOT

(71) Applicant: GM GLOBAL TECHNOLOGY OPERATIONS LLC, Detroit, MI (US)

(72) Inventors: Kevin A. O'DEA, Ann Arbor, MI (US); Bryan M. JOYNER, Clarkston, MI (US)

(21) Appl. No.: 18/635,625

(22) Filed: Apr. 15, 2024

(51) Int. Cl. G06V 20/56; G02B 27/00; G06F 3/01; G06V 20/58

(52) U.S. Cl. CPC G06V 20/588; G02B 27/0093; G06F 3/013; G06V 20/58

(57) ABSTRACT

A system for a vehicle includes: a module configured to, when enabled, selectively perform a vehicle feature; a parking lot module configured to determine and indicate whether the vehicle is presently in a parking lot based on at least two of: a present vehicle speed of the vehicle; a steering wheel angle of the vehicle; a gaze of a driver of the vehicle; a confidence value corresponding to a confidence that the vehicle is in a parking lot; and a parking space confidence value corresponding to a confidence that a perception module has detected a parking space around the vehicle; and an enabling/disabling module configured to: enable the module when the vehicle is not in a parking lot; and disable the module when the vehicle is in a parking lot.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle sensors and cameras and more particularly to systems and methods for determining whether a vehicle is in a parking lot.

Vehicles include one or more torque producing devices, such as an internal combustion engine and/or an electric motor. A passenger of a vehicle rides within a passenger cabin (or passenger compartment) of the vehicle.

Vehicles may include one or more different types of sensors that sense vehicle surroundings. One example of a sensor that senses vehicle surroundings is a camera configured to capture images of the vehicle surroundings. Examples of such cameras include forward-facing cameras, rear-facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

### SUMMARY

In a feature, a system for a vehicle is described and includes: a module configured to, when enabled, selectively perform a vehicle feature; a parking lot module configured to determine and indicate whether the vehicle is presently in a parking lot based on at least two of: a present vehicle speed of the vehicle; a steering wheel angle of the vehicle; a gaze of a driver of the vehicle; a confidence value corresponding to a confidence that the vehicle is in a parking lot; and a parking space confidence value corresponding to a confidence that a perception module has detected a parking space around the vehicle; and an enabling/disabling module configured to: enable the module when the vehicle is not in a parking lot; and disable the module when the vehicle is in a parking lot.

In further features, the parking lot module is configured to selectively determine and indicate that the vehicle is presently in a parking lot when the present vehicle speed of the vehicle is within a predetermined speed range.

In further features, the parking lot module is configured to determine and indicate that the vehicle is not presently in a parking lot when the present vehicle speed of the vehicle is outside of the predetermined speed range.

In further features, the parking lot module is configured to selectively determine and indicate that the vehicle is presently in a parking lot when the steering wheel angle of the vehicle is greater than a predetermined steering wheel angle.

In further features, the parking lot module is configured to selectively determine and indicate that the vehicle is presently in a parking lot when the steering wheel angle of the vehicle has been greater than the predetermined steering wheel angle within a past predetermined period.

In further features, the parking lot module is configured to determine and indicate that the vehicle is not presently in a parking lot when the present vehicle speed of the vehicle is not greater than the predetermined steering wheel angle.

In further features, the parking lot module is configured to selectively determine and indicate that the vehicle is presently in a parking lot when the gaze of the driver has been left or right of a forward direction of travel of the vehicle.

In further features, the parking lot module is configured to determine and indicate that the vehicle is not presently in a parking lot when the gaze of the driver has not been left or right of a forward direction of travel of the vehicle within a past predetermined period.

In further features, the parking lot module is configured to selectively determine and indicate that the vehicle is presently in a parking lot when the confidence value is greater than a predetermined value.

In further features, the parking lot module is configured to determine and indicate that the vehicle is not presently in a parking lot when the confidence value is less than the predetermined value.

In further features, a confidence module is configured to determine the confidence value based on a number of pedestrians detected around the vehicle.

In further features, the confidence module is configured to increase the confidence value as the number of pedestrians detected around the vehicle increases and to decrease the confidence value as the number of pedestrians detected around the vehicle decreases.

In further features, a confidence module is configured to determine the confidence value based on a number of lane lines detected in front of the vehicle, the lane lines dividing lanes of vehicle traffic.

In further features, the confidence module is configured to increase the confidence value as the number of lane lines detected in front of the vehicle decreases and to decrease the confidence value as the lane lines detected in front of the vehicle increases.

In further features, the parking lot module is configured to selectively determine and indicate that the vehicle is presently in a parking lot when the parking space confidence value is greater than a predetermined value.

In further features, a perception module is configured to detect parking spaces based on images captured using cameras of the vehicle and to set the parking space confidence value based on a number of parking spaces detected.

In further features, the perception module is configured to increase the parking space confidence value as the number of parking spaces detected increases and to decrease the parking space confidence value as the number of parking spaces detected decreases.

In further features, the parking lot module is configured to determine and indicate that the vehicle is presently in a parking lot when at least two of: the present vehicle speed of the vehicle is within a predetermined speed range; the steering wheel angle of the vehicle is greater than a predetermined steering wheel angle; the gaze of the driver has been left or right of a forward direction of travel of the vehicle; the confidence value is greater than a predetermined value; and the parking space confidence value is greater than a predetermined value.

In further features, the parking lot module is configured to determine and indicate that the vehicle is presently in a parking lot when all of: the present vehicle speed of the vehicle is within a predetermined speed range; the steering wheel angle of the vehicle is greater than a predetermined steering wheel angle; the gaze of the driver has been left or right of a forward direction of travel of the vehicle; the confidence value is greater than a predetermined value; and the parking space confidence value is greater than a predetermined value.

In a feature, a method for a vehicle includes: when a vehicle feature is enabled, selectively performing the vehicle feature; determining and indicating whether the vehicle is presently in a parking lot based on at least two of: a present vehicle speed of the vehicle; a steering wheel angle of the vehicle; a gaze of a driver of the vehicle; a confidence value corresponding to a confidence that the vehicle is in a parking lot; and a parking space confidence value corresponding to a confidence that a perception module has detected a parking space around the vehicle; enabling the vehicle feature when the vehicle is not in a parking lot; and disabling the vehicle feature when the vehicle is in a parking lot.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of a vehicle including various external cameras and sensors;

FIG. 3 is a functional block diagram of a control system; and

FIG. 4 is a flowchart depicting an example method of disabling one or more vehicle features, such as cruise control, when the vehicle is in a parking lot.

In the drawings, reference numbers may be reused to identify similar and/or identical elements.

### DETAILED DESCRIPTION

A vehicle may include a camera configured to capture images within a predetermined field of view (FOV) around an exterior of the vehicle. A perception module may perceive objects around the vehicle and determine locations of the objects. For example, a camera may be used to capture images including a road in front of the vehicle. Lane lines and objects around the vehicle can be identified using images from the camera and one or more other cameras and/or sensors.

Some vehicle features may automatically be enabled. For example, cruise control or adaptive cruise control may automatically enable in some circumstances. Cruise control may involve one or more control modules controlling vehicle speed based on a target vehicle speed. Adaptive cruise control may involve one or more control modules controlling vehicle speed based on a target vehicle speed while maintaining at least a predetermined distance between the vehicle and an object in front of the vehicle.

The present application involves detecting whether or not the vehicle is in a parking lot. When the vehicle is in a parking lot, one or more control modules disable one or more vehicle features. For example, the one or more control modules may disable cruise control and/or adaptive cruise control when the vehicle is in a parking lot. The vehicle features may be allowed and may be automatically enabled when the vehicle is not in a parking lot.

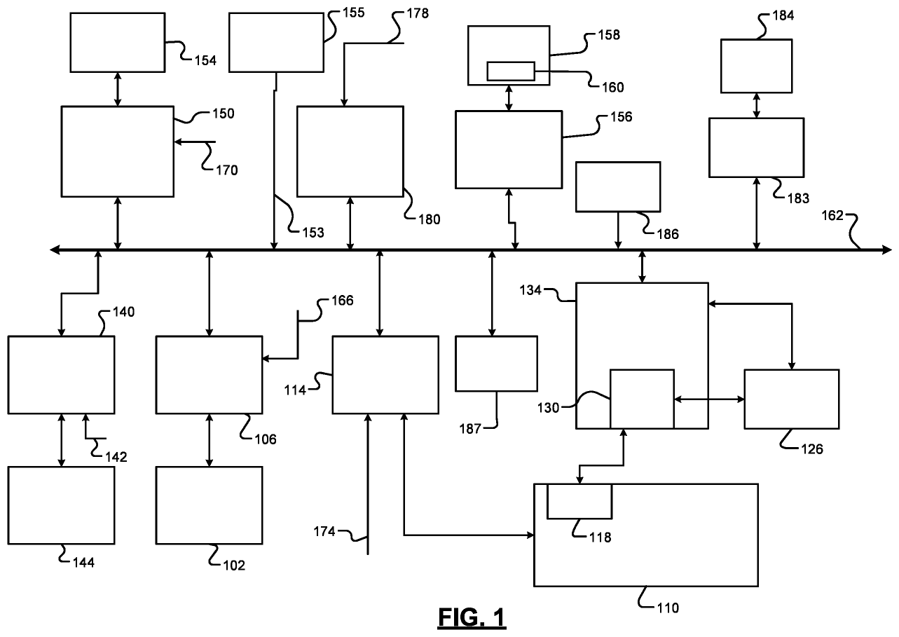

Referring now to FIG. 1, a functional block diagram of an example vehicle system is presented. While a vehicle system for a hybrid vehicle is shown and will be described, the present application is also applicable to non-hybrid vehicles, electric vehicles, fuel cell vehicles, and other types of vehicles. The present application is applicable to autonomous vehicles, semi-autonomous vehicles, non-autonomous vehicles, shared vehicles, non-shared vehicles, and other types of vehicles.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may include, for example, an inverter.

A steering control module 140 controls steering/turning of wheels of the vehicle, for example, based on driver turning of a steering wheel within the vehicle and/or steering commands from one or more vehicle control modules. A steering wheel angle (SWA) sensor (not shown) monitors rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system.

A brake control module 150 may selectively control (e.g., friction) brakes 154 of the vehicle based on one or more driver inputs, such as a brake pedal position (BPP) 170. Another driver input may be a cruise control input 153 from a cruise control module 155 when cruise control is enabled.

A damper control module 156 controls damping of dampers 158 of the wheels, respectively, of the vehicle. The dampers 158 damp vertical motion of the wheels. The damper control module 156 may control, for example, damping coefficients of the dampers 158, respectively. For example, the dampers 158 may include magnetorheological dampers, continuous damping control dampers, or another suitable type of adjustable damper. The dampers 158 include actuators 160 that adjust damping of the dampers 158, respectively. In the example of magnetorheological dampers, the actuators 160 may adjust magnetic fields applied to magnetorheological fluid within the dampers 158, respectively, to adjust damping.

Modules of the vehicle may share parameters via a network 162, such as a controller area network (CAN). A CAN may also be referred to as a car area network. For example, the network 162 may include one or more data buses. Various parameters may be made available by a given module to other modules via the network 162.

The driver inputs may include, for example, an accelerator pedal position (APP) 166 which may be provided to the ECM 106. The BPP 170 may be provided to the brake control module 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

An infotainment module 183 may output various information via one or more output devices 184. The output devices 184 may include, for example, one or more displays (non-touch screen and/or touch screen), one or more other suitable types of video output devices, one or more speakers, one or more haptic devices, and/or one or more other suitable types of output devices.

The infotainment module 183 may output video via the one or more displays. The infotainment module 183 may output audio via the one or more speakers. The infotainment module 183 may output other feedback via one or more haptic devices. For example, haptic devices may be included with one or more seats, in one or more seat belts, in the steering wheel, etc. Examples of displays may include, for example, one or more displays (e.g., on a front console) of the vehicle, a head up display (HUD) that displays information via a substrate (e.g., windshield), one or more displays that drop downwardly or extend upwardly to form panoramic views, and/or one or more other suitable displays.

The vehicle may include a plurality of external sensors and cameras, generally illustrated in FIG. 1 by 186. One or more actions may be taken based on input from the external sensors and cameras 186. For example, the infotainment module 183 may display video, various views, and/or alerts on a display via input from the external sensors and cameras 186 during driving.

As another example, brake control module 150 and/or the steering control module 140 may apply the brakes 154 and/or steer the vehicle to avoid the vehicle colliding with an object around the vehicle.

The vehicle may include one or more additional control modules that are not shown, such as a chassis control module, a battery pack control module, etc. The vehicle may omit one or more of the control modules shown and discussed.

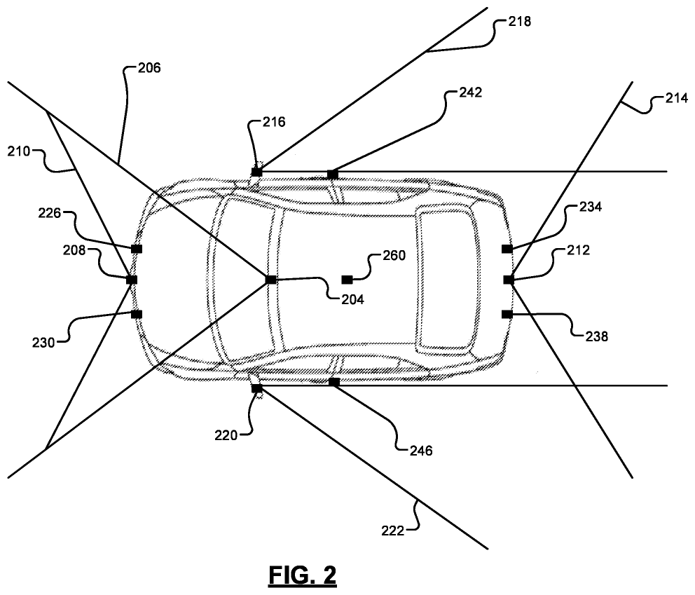

Referring now to FIG. 2, a functional block diagram of a vehicle including examples of external sensors and cameras is presented. The external sensors and cameras 186 (FIG. 1) include various cameras positioned to capture images and video outside of (external to) the vehicle and various types of sensors measuring parameters outside of (external to) the vehicle. Examples of the external sensors and cameras 186 will now be discussed. For example, a forward-facing camera 204 captures images and video of images within a predetermined field of view (FOV) 206 in front of the vehicle.

A front camera 208 may also capture images and video within a predetermined FOV 210 in front of the vehicle. The front camera 208 may capture images and video within a predetermined distance of the front of the vehicle and may be located at the front of the vehicle (e.g., in a front fascia, grille, or bumper). The forward-facing camera 204 may be located more rearward, however, such as with a rear-view mirror at a windshield of the vehicle. The forward-facing camera 204 may not be able to capture images and video of items within all of or at least a portion of the predetermined FOV of the front camera 208 and may capture images and video more than the predetermined distance of the front of the vehicle. In various implementations, only one of the forward-facing camera 204 and the front camera 208 may be included.

A rear camera 212 captures images and video within a predetermined FOV 214 behind the vehicle. The rear camera 212 may be located at the rear of the vehicle, such as near a rear license plate.

A right camera 216 captures images and video within a predetermined FOV 218 to the right of the vehicle. The right camera 216 may capture images and video within a predetermined distance to the right of the vehicle and may be located, for example, under a right side rear-view mirror. In various implementations, the right side rear-view mirror may be omitted, and the right camera 216 may be located near where the right side rear-view mirror would normally be located.

A left camera 220 captures images and video within a predetermined FOV 222 to the left of the vehicle. The left camera 220 may capture images and video within a predetermined distance to the left of the vehicle and may be located, for example, under a left side rear-view mirror. In various implementations, the left side rear-view mirror may be omitted, and the left camera 220 may be located near where the left side rear-view mirror would normally be located. While the example FOVs are shown for illustrative purposes, the present application is also applicable to other FOVs. In various implementations, FOVs may overlap, for example, for more accurate and/or inclusive stitching.

The external sensors and cameras 186 may additionally or alternatively include various other types of sensors, such as light detection and ranging (LIDAR) sensors, ultrasonic sensors, radar sensors, and/or one or more other types of sensors. For example, the vehicle may include one or more forward-facing ultrasonic sensors, such as forward-facing ultrasonic sensors 226 and 230, one or more rearward facing ultrasonic sensors, such as rearward facing ultrasonic sensors 234 and 238. The vehicle may also include one or more right side ultrasonic sensors, such as right side ultrasonic sensor 242, and one or more left side ultrasonic sensors, such as left side ultrasonic sensor 246. The vehicle may also include one or more light detection and ranging (LIDAR) sensors, such as LIDAR sensor 260. The locations of the cameras and sensors are provided as examples only and different locations could be used. Ultrasonic sensors output ultrasonic signals around the vehicle.

The external sensors and cameras 186 may additionally or alternatively include one or more other types of sensors, such as one or more sonar sensors, one or more radar sensors, and/or one or more other types of sensors.

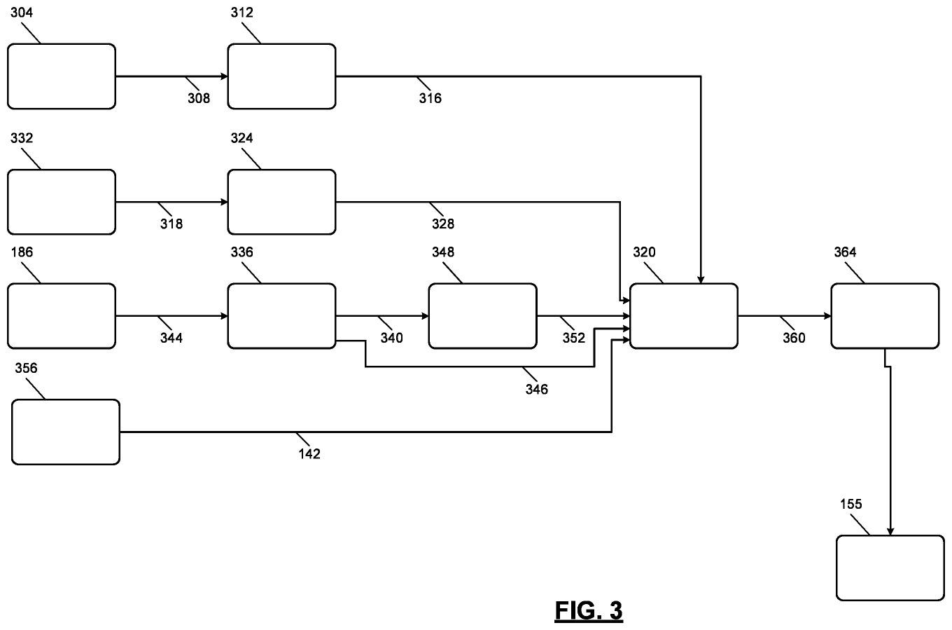

FIG. 3 is a functional block diagram of an example implementation of a control system. A driver facing camera 304 is disposed within the passenger cabin of the vehicle and faces a driver's seat. The driver's seat of the vehicle is within a FOV of the driver facing camera 304. A driver sitting on the driver's seat is captured in images 308 from the driver facing camera 304. The driver facing camera 304 may capture the images at a predetermined rate, such as a rate corresponding Hertz (Hz) or another suitable frequency.

A driver monitoring module 312 determines a present gaze 316 of the driver based on a most recently captured image 308 including the driver. The gaze 316 may be, for example, a vector in a direction where eyes of the driver are presently looking. The driver monitoring module 312 may update the present gaze 316 for each image 308 captured.

A parking lot module 320 determines whether the vehicle is presently in a parking lot based on the gaze 316 of the driver and other parameters as discussed further below.

A vehicle speed module 324 determines a present vehicle speed 328 (speed of the vehicle). The vehicle speed module 324 may determine the vehicle speed 328, for example, based on one or more wheel speeds 318 measured by one or more wheel speed sensors 332, respectively. For example, the vehicle speed module 324 may set the vehicle speed 328 based on or equal to an average of two or more of the wheel speeds 318 (e.g., of driven wheels). The wheel speed sensors 332 may determine the wheel speeds 318 based on rotational speeds of respective wheels.

The parking lot module 320 determines whether the vehicle is presently in a parking lot further based on the vehicle speed 328.

A perception module 336 detects and determines locations of features 340 around the vehicle based on input 344 from the external cameras and sensors 186. Examples of features include pedestrians, lane lines, vehicles, and other visually identifiable features.

The perception module 336 may also detect the presence of parking spaces/spots around the vehicle based on the input 344 from the external cameras and sensors 186. The perception module 336 may detect the presence of a parking spot, for example, based on the presence of two parallel lines on the ground that extend a predetermined angle away from the forward direction of travel of the vehicle. The perception module 336 generates a parking spot confidence value 346 that indicates a confidence that a parking spot has been detected. For example, the parking spot confidence value 346 may be a value between 0 and 100 where higher values indicate increased confidence of the presence of a parking spot and vice versa.

A confidence module 348 determines a confidence value 352 based on the features detected by the perception module 336. The confidence value 352 may correspond to a level of confidence of the vehicle presently being located within a parking lot. For example, the confidence value 352 may be a value between 0 and 100 where higher values indicate increased confidence that the vehicle is within a parking lot and vice versa. The confidence module 348 may set the confidence value 352, for example, as a function of a number of pedestrians detected around the vehicle and a number of lane lines detected in front of the vehicle. For example, the confidence module 348 may increase the confidence value as the number of pedestrians increases and vice versa. An increased number of pedestrians are more often found in parking lots than in other places. The confidence module 348 may increase the confidence value as the number of lane lines in front of the vehicle decreases and vice versa. Typically, no or few lane lines are present in parking lots.

The parking lot module 320 determines whether the vehicle is presently in a parking lot further based on the confidence value 352.

A steering wheel angle (SWA) sensor 356 measures the SWA 142 based on the rotational position of the steering wheel. The parking lot module 320 determines whether the vehicle is presently in a parking lot further based on the SWA 142.

For example, the parking lot module 320 may determine that the vehicle is in a parking lot when all of (a) the vehicle speed 328 is within a predetermined speed range, (b) the gaze 316 of the driver is or has been left or right of forward within a first predetermined period, (c) the confidence value 352 is greater than a predetermined value, (d) the SWA 142 has been greater than a predetermined angle at least once within a second predetermined period, and (e) the parking spot confidence value 346 is greater than the predetermined value. The parking lot module 320 may determine that the vehicle is not in a parking lot when one or of (a), (b), (c), (d), and (e) are not satisfied.

The predetermined speed range may be, for example, 1 mile per hour to 25 miles per hour or another suitable range. The predetermined value may be, for example, 75-80 or another suitable value for confidence values that range from 0 to 100. The first predetermined period may be, for example, 10 seconds or another suitable period. The second predetermined period may be since the vehicle speed 328 has been less than the upper limit of the predetermined speed range or 10 seconds or another suitable period.

The parking lot module 320 generates a parking lot indicator 360 that indicates whether the vehicle is in a parking lot. For example, the parking lot module 320 may set the parking lot indicator 360 to a first state when the vehicle is in a parking lot. The parking lot module 320 may set the parking lot indicator 360 to a second state when the vehicle is not in a parking lot.

An enabling/disabling module 364 enables and disables the cruise control module 155 based on the parking lot indicator 360. For example, the enabling/disabling module 364 disables the cruise control module 155 when the parking lot indicator 360 indicates that the vehicle is in a parking lot. The enabling/disabling module 364 enables the cruise control module 155 when the parking lot indicator 360 indicates that the vehicle is in a parking lot. When the cruise control module 155 is enabled, the cruise control module 155 may activate cruise control when one or more predetermined conditions are satisfied. By disabling the cruise control module 155 when the vehicle is in a parking lot, automatic activation of cruise control may be avoided when the vehicle is in a parking lot. While the example of cruise control is provided, the present application may also be applicable to disabling other vehicle features when the vehicle is in a parking lot.

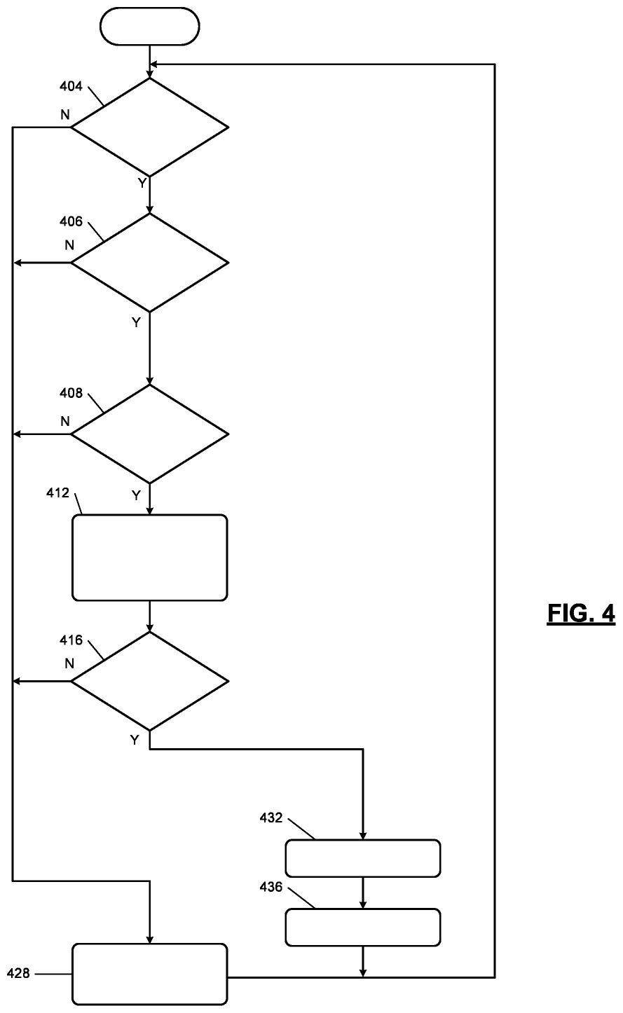

FIG. 4 is a flowchart depicting an example method of disabling one or more vehicle features, such as cruise control, when the vehicle is in a parking lot.

Control may begin with 404 where the parking lot module 320 determines whether the vehicle speed 328 is within the predetermined speed range. Vehicles typically maintain speeds within the predetermined speed range when in parking lots. If 404 is true, control continues with 406. If 404 is false, control may transfer to 428 where the parking lot module 320 indicates that the vehicle is not in a parking lot and enables the cruise control module 155 and control returns to 404.

At 406, the parking lot module 320 may determine whether the SWA 142 has been greater than a predetermined angle (e.g., at least 60 degrees of rotation or another suitable value) within a predetermined period. The predetermined period may be, for example, 10 seconds, since the vehicle speed 328 has been within the predetermined speed range, or another suitable period. If 406 is false, control may transfer to 428 where the parking lot module 320 indicates that the vehicle is not in a parking lot and the cruise control module 155 is enabled. If 406 is true, control may transfer to 408.

At 408, the parking lot module 408 determines whether the gaze 316 of the driver has been left or right of forward based on sliding mode state estimation with calibratable weighting factors. The driver moving his or her gaze leftward or rightward may be indicative of looking for a parking space. If 408 is true, control may continue with 412. If 408 is false, control may transfer to 428 where the parking lot module 320 indicates that the vehicle is not in a parking lot and the cruise control module 155 is enabled.

At 412, the perception module 336 may determine the parking lot confidence value 346 and the confidence module 348 may determine the confidence value 352. The parking lot confidence value 346 may increase as confidence that one or more parking spaces have been detected increases and vice versa. The confidence value 352 may increase as confidence that vehicle is in a parking lot increases and vice versa.

At 416, the parking lot module 320 may determine whether the parking lot confidence value 346 and the confidence value 352 are greater than predetermined values. In various implementations, the parking lot module 320 may require that the parking lot confidence value 346 and/or the confidence value 352 may be greater than the respective predetermined value continuously for a predetermined period or for at least X out of the last Y instances of 416. The predetermined values may be, for example, 75-80 or other suitable values in the example of values that range from 0 to 100. If 416 is true, control continues with 432. If 416 is false, control may transfer to 428 where the parking lot module 320 indicates that the vehicle is not in a parking lot and the cruise control module 155 is enabled.

At 432, the parking lot module 320 determines and indicates that the vehicle is in a parking lot. At 436, based on the indication that the vehicle is in a parking lot, the enabling/disabling module 364 disables the cruise control module 155. This prevents cruise control from being activated, such as automatically or in response to user input requesting cruise control.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for a vehicle, comprising:
a module configured to, when enabled, selectively perform a vehicle feature;
a parking lot module configured to determine and indicate whether the vehicle is presently in a parking lot based on at least two of:
a present vehicle speed of the vehicle;
a steering wheel angle of the vehicle;
a gaze of a driver of the vehicle;
a confidence value corresponding to a confidence that the vehicle is in a parking lot; and
a parking space confidence value corresponding to a confidence that a perception module has detected a parking space around the vehicle; and
an enabling/disabling module configured to:
enable the module when the vehicle is not in a parking lot; and
disable the module when the vehicle is in a parking lot.

2. The system of claim 1 wherein the parking lot module is configured to selectively determine and indicate that the vehicle is presently in a parking lot when the present vehicle speed of the vehicle is within a predetermined speed range.

3. The system of claim 2 wherein the parking lot module is configured to determine and indicate that the vehicle is not presently in a parking lot when the present vehicle speed of the vehicle is outside of the predetermined speed range.

4. The system of claim 1 wherein the parking lot module is configured to selectively determine and indicate that the vehicle is presently in a parking lot when the steering wheel angle of the vehicle is greater than a predetermined steering wheel angle.

5. The system of claim 4 wherein the parking lot module is configured to selectively determine and indicate that the vehicle is presently in a parking lot when the steering wheel angle of the vehicle has been greater than the predetermined steering wheel angle within a past predetermined period.

6. The system of claim 4 wherein the parking lot module is configured to determine and indicate that the vehicle is not presently in a parking lot when the present vehicle speed of the vehicle is not greater than the predetermined steering wheel angle.

7. The system of claim 1 wherein the parking lot module is configured to selectively determine and indicate that the vehicle is presently in a parking lot when the gaze of the driver has been left or right of a forward direction of travel of the vehicle.

8. The system of claim 7 wherein the parking lot module is configured to determine and indicate that the vehicle is not presently in a parking lot when the gaze of the driver has not been left or right of a forward direction of travel of the vehicle within a past predetermined period.

9. The system of claim 1 wherein the parking lot module is configured to selectively determine and indicate that the vehicle is presently in a parking lot when the confidence value is greater than a predetermined value.

10. The system of claim 9 wherein the parking lot module is configured to determine and indicate that the vehicle is not presently in a parking lot when the confidence value is less than the predetermined value.

11. The system of claim 9 further comprising a confidence module configured to determine the confidence value based on a number of pedestrians detected around the vehicle.

12. The system of claim 11 wherein the confidence module is configured to increase the confidence value as the number of pedestrians detected around the vehicle increases and to decrease the confidence value as the number of pedestrians detected around the vehicle decreases.

13. The system of claim 9 further comprising a confidence module configured to determine the confidence value based on a number of lane lines detected in front of the vehicle, the lane lines dividing lanes of vehicle traffic.

14. The system of claim 13 wherein the confidence module is configured to increase the confidence value as the number of lane lines detected in front of the vehicle decreases and to decrease the confidence value as the lane lines detected in front of the vehicle increases.

15. The system of claim 1 wherein the parking lot module is configured to selectively determine and indicate that the vehicle is presently in a parking lot when the parking space confidence value is greater than a predetermined value.

16. The system of claim 15 further comprising a perception module configured to detect parking spaces based on images captured using cameras of the vehicle and to set the parking space confidence value based on a number of parking spaces detected.

17. The system of claim 16 wherein the perception module is configured to increase the parking space confidence value as the number of parking spaces detected increases and to decrease the parking space confidence value as the number of parking spaces detected decreases.

18. The system of claim 1 wherein the parking lot module is configured to determine and indicate that the vehicle is presently in a parking lot when at least two of:
the present vehicle speed of the vehicle is within a predetermined speed range;
the steering wheel angle of the vehicle is greater than a predetermined steering wheel angle;
the gaze of the driver has been left or right of a forward direction of travel of the vehicle;
the confidence value is greater than a predetermined value; and
the parking space confidence value is greater than a predetermined value.

19. The system of claim 1 wherein the parking lot module is configured to determine and indicate that the vehicle is presently in a parking lot when all of:
the present vehicle speed of the vehicle is within a predetermined speed range;
the steering wheel angle of the vehicle is greater than a predetermined steering wheel angle;
the gaze of the driver has been left or right of a forward direction of travel of the vehicle;
the confidence value is greater than a predetermined value; and
the parking space confidence value is greater than a predetermined value.

20. A method for a vehicle, the method comprising:
when a vehicle feature is enabled, selectively performing the vehicle feature;
determining and indicating whether the vehicle is presently in a parking lot based on at least two of:
a present vehicle speed of the vehicle;
a steering wheel angle of the vehicle;
a gaze of a driver of the vehicle;
a confidence value corresponding to a confidence that the vehicle is in a parking lot; and
a parking space confidence value corresponding to a confidence that a perception module has detected a parking space around the vehicle;
enabling the vehicle feature when the vehicle is not in a parking lot; and
disabling the vehicle feature when the vehicle is in a parking lot.
